(19) United States
(12) Patent Application Publication
(10) Pub. No.: US 2018/0351178 A1
(43) Pub. Date: Dec. 6, 2018

(54) Application of terpene resin-based composite binder in electrochemical energy storage device

(71) Applicant: SHENZHEN XIN CHANG LONG NEW MATERIALS TECHNOLOGY CO., LTD., Shenzhen, Guandong (CN)

(72) Inventors: Lingzhi ZHANG, Guangzhou (CN); Jiarong HE, Guangzhou (CN); Haoxiang ZHONG, Guangzhou (CN)

(73) Assignee: Shenzhen MPD Hitech Co., Ltd, Shenzhen (CN)

(21) Appl. No.: 15/771,480

(22) PCT Filed: Jan. 4, 2016
(86) PCT No.: PCT/CN2016/070066

§ 371 Date: Apr. 27, 2018

(30) Foreign Application Priority Data
Oct. 29, 2015 (CN) 201510727775.3

(51) Int. Cl. H01M 4/62; H01M 10/0525; H01M 4/525; H01M 4/505; H01G 11/28

(52) U.S. Cl. CPC H01M 4/622; H01M 10/0525; H01M 2004/028; H01M 4/505; H01G 11/28; H01M 4/525

(57) ABSTRACT

The present invention relates to a terpene resin-based composite binder for the preparation of electrodes of lithium-ion battery cathode or supercapacitor. The terpene resin-based composite binder is a terpene resin-based aqueous binder or a terpene resin-based oil binder; the terpene resin-based aqueous binder comprises a water-soluble terpene resin emulsion and a water-soluble polymer auxiliary agent, the water-soluble polymer auxiliary agent is one or more selected from the group of carboxymethyl cellulose, polyacrylic acid or metal salts, a mass ratio of a terpene resin in the water-soluble terpene resin emulsion to the water-soluble polymer auxiliary agent is 50:1 to 1:50; the terpene resin-based oil binder comprises an oil-soluble terpene resin and an oil-soluble polymer auxiliary agent, the oil-soluble polymer auxiliary agent is a polyvinylidene fluoride, a mass ratio of the oil-soluble terpene resin to the polyvinylidene fluoride ranges from 1:4 to 1:50.

### CROSS REFERENCE TO RELATED APPLICATIONS

This application is the national phase entry of International Application No. PCT/CN2016/070066, filed on Jan. 4, 2016, which is based upon and claims priority to Chinese Patent Application No. CN201510727775.3, filed on Oct. 29, 2015, the entire contents of which are incorporated herein by reference.

### TECHNICAL FIELD

The present invention relates to a binder, in particular to application of a terpene resin-based composite binder in an electrochemical energy storage device.

### BACKGROUND

In the manufacturing process of a battery or a supercapacitor, binder is necessary to process an electrode active material. Binder is a macromolecular compound that is used to adhere an electrode active material and a conductive agent to a current collector. For a long time, polyvinylidene fluoride (PVDF) is mainly used as a binder and organic solvent N-methylpyrrolidone (NMP) is mainly used as a dispersant in the industrial-scale production of lithium-ion batteries. However, PVDF has many shortcomings, such as poor conductivity of electrons and ions, likely to swell in the electrolyte and big security risk caused by exothermic reaction with metallic lithium and LiₓC₆ at higher temperatures. In addition, the Young's modulus of PVDF is relatively high, the flexibility of the polar piece is not good enough, the molecular weight is decreased after absorbing water, and the viscosity is poor. Therefore, the humidity requirements of the environment are relatively high, the energy consumption is large, and the production cost is high. At the same time, NMP, an organic solvent used to dissolve PVDF, is volatile, flammable, explosive and toxic. NMP volatilization not only seriously endangers the health of the production workshop staff, but also causes serious environmental pollution and high recovery costs. Therefore, searching for a new type of green aqueous binder that can replace organic solvent-based PVDF has far-reaching significance, which has gradually become an important development direction for lithium-ion battery binders so as to meet the requirements of green energy-saving production in modern society. Terpene resin (C₅H₈)ₙ, also known as polyterpene or pinene resin, is a natural hydrocarbons widely found in plant and marine organisms, terpene resin (C₅H₈)ₙ is also widely used as matrix of pressure-sensitive binders, hot melt binders and tackifier, and widely used in the industries of coatings, rubber, plastics, printing, health and food packaging, ion exchange resins, potassium synergist and the like, as terpene resin (C₅H₈)ₙ has the characteristics of low odor, no toxicity, no crystallization, resistance to dilute acid and alkali, heat resistance, light resistance, anti-aging, strong adhesion, high adhesive force, good thermal stability, excellent compatibility and solubility etc. In 2014, the applicant of the present invention submitted an invention patent (201410229082.7) of a natural high molecular terpene resin-based aqueous binder and application thereof in lithium-ion battery cathode or supercapacitor, and the invention has good technical effect. In addition, JP5-74461 obtained a water-based binder of lithium-ion battery cathode by mixing carboxymethyl cellulose (CMC) with styrene butadiene rubber latex (SBR), which has been rapidly developed, and widely and commercially used in preparing lithium-ion battery graphite anode. However, lithium battery cathode has not been commercialized yet. The main reason is that the potential plateau of cathode material is relatively high, when compared with graphite anode material, the cathode material generally has poor electrical conductivity and problems such as it is easy to aggregate and difficult to disperse. What's more, cathode material and anode material have different technical requirements for the water-based binder. Compared with anode material, the water-based binder of the cathode material requires higher oxidation resistance and can withstand repeated cycles of charge and discharge at higher potential, while the water-based binder of the anode material requires better reduction-resisting. Compared with anode material, cathode material plays a more crucial role on the performance of battery. Therefore, water-based binders for cathode material is the technological frontier of research and development of related materials in the lithium battery industry. However, the current PVDF binder used for lithium-ion battery cathode is expensive, and it is urgently needed to research and develop a new type of water-based binder for lithium-ion battery cathode to reduce the production cost. Terpene resin-based composite binder of the present invention used in lithium-ion battery cathode or supercapacitor can significantly improve the high rate performance and cycle stability, and reduce the electrochemical interface impedance. Compared with the current PVDF binder system for lithium-ion battery cathode, the terpene resin has a wide range of sources and is green and environment friendly and low in cost. It is of great significance to research and develop a new type of terpene resin-based composite binder to solve dispersion problem of cathode slurry, contribute to the green technology development of lithium-ion battery and supercapacitor electrode preparation and the reduction of production cost, and promote technological progress of lithium-ion battery industry and even development of strategic emerging industries such as electric vehicles.

### SUMMARY OF THE INVENTION

The purpose of the present invention is to overcome the deficiencies in the prior art and provide an application of terpene resin-based composite binder in the preparation of electrodes of lithium-ion battery cathode or supercapacitor. The present invention provides a lithium-ion battery cathode electrode, also provides a supercapacitor electrode. The present invention also provides a lithium-ion battery and supercapacitor.

In order to achieve the above object, the present invention uses the following technical solution: an application of terpene resin-based composite binder in the preparation of electrodes of lithium-ion battery cathode or supercapacitor.

Preferably, the terpene resin-based composite binder is a terpene resin-based aqueous binder or a terpene resin-based oil binder.

The terpene resin-based aqueous binder includes a water-soluble terpene resin emulsion and a water-soluble polymer auxiliary agent; the water-soluble polymer auxiliary agent is one or more selected from the group of carboxymethyl cellulose, polyacrylic acid or metal salts. The mass ratio of terpene resin in the terpene resin emulsion to the water-soluble polymer auxiliary agent is 50:1 to 1:50.

Terpene resin-based oil binder includes an oil-soluble terpene resin and an oil-soluble polymer auxiliary agent, the oil-soluble polymer auxiliary agent is polyvinylidene fluoride (PVDF), the mass ratio of the oil-soluble terpene resin to the polyvinylidene fluoride is 1:4 to 1:50.

The present invention provides a lithium-ion battery cathode electrode, the lithium-ion battery cathode electrode includes a current collector and a lithium-ion battery cathode slurry loaded on the current collector; the lithium-ion battery cathode slurry includes a positive active material, a conductive agent, a binder and a solvent.

The binder is a terpene resin-based composite binder; and the mass ratio of the positive active material, the conductive agent and the binder is 70-95:1-20:4-10.

Preferably, the binder is a terpene resin-based aqueous binder, the terpene resin-based aqueous binder includes a water-soluble terpene resin emulsion and a water-soluble polymer auxiliary agent, the water-soluble polymer auxiliary agent is one or more selected from the group of carboxymethyl cellulose, polyacrylic acid or metal salts. The mass ratio of terpene resin in the terpene resin emulsion to the water-soluble polymer auxiliary agent is 50:1 to 1:50; the solvent is water. The terpene resin emulsion of the present invention is obtained by emulsifying a terpene resin and a polymer surfactant. The terpene resin emulsion or terpene resin solid used in the present invention can be directly purchased from the market. More preferably, the mass concentration of the terpene resin in the terpene resin emulsion is 55%, the viscosity of the terpene resin emulsion ranges from 3000 to 8000 mPa·s.

Preferably, the binder is a terpene resin-based oil binder, the terpene resin-based oil binder includes an oil-soluble terpene resin and an oil-soluble polymer auxiliary agent, the oil-soluble polymer auxiliary agent is polyvinylidene fluoride (PVDF), the mass ratio of the oil-soluble terpene resin to the polyvinylidene fluoride is 1:4-1:50, the solvent is N-methylpyrrolidone.

Preferably, the positive active material is one or more selected from the group of lithium iron phosphate, lithium cobalt oxide, lithium manganate or ternary material; the conductive agent is a conductive carbon material; the current collector is an aluminum foil current collector.

The solid content of the lithium-ion battery cathode slurry is 30-75%, the viscosity of the lithium-ion battery cathode slurry ranges from 3000 to 8000 mPa·s. More preferably, the conductive agent is acetylene black.

The present invention provides a supercapacitor electrode, the supercapacitor electrode includes a current collector and an electrode slurry loaded on the current collector; the electrode slurry includes an active material, a conductive agent, a binder and a solvent.

The binder is a terpene resin-based oil binder, the mass ratio of the active material, the conductive agent and the binder is 70-95:1-20:4-10.

Preferably, the terpene resin-based oil binder includes an oil-soluble terpene resin and an oil-soluble polymer auxiliary agent, the oil-soluble polymer auxiliary agent is polyvinylidene fluoride (PVDF), the mass ratio of the oil-soluble terpene resin to the polyvinylidene fluoride is 1:4 to 1:50, the solvent is N-A Pyrrolidone.

Preferably, the active material is an activated carbon, the conductive agent is a conductive carbon material, the current collector is an aluminum foil current collector.

The solid content of the supercapacitor electrode slurry is 30% to 75%, the viscosity of the supercapacitor electrode slurry ranges from 3000 to 8000 mPa·s. More preferably, the conductive agent is acetylene black.

The present invention provides a lithium-ion battery, the lithium-ion battery includes the lithium-ion battery cathode electrode described above.

The present invention provides a supercapacitor, the supercapacitor includes the supercapacitor electrode described above.

The present invention has the following advantages:

The present invention provides an application of a terpene resin-based composite binder in the preparation of electrodes of lithium-ion batteries cathode or supercapacitor. Compared with the prior art, the present invention has the following advantages:

1) The terpene resin-based aqueous binder provided by the present invention is used for lithium-ion battery cathode material, which can reduce the electrochemical interface impedance.

2) Application of the terpene resin-based aqueous binder provided by the present invention in lithium-ion battery cathode can greatly improve the material's high rate performance and battery's cycle stability.

3) Application of the terpene resin-based oil binder provided by the present invention in lithium-ion battery cathode and supercapacitor can improve the cycle stability of the battery and significantly reduce the production cost.

4) The terpene resin provided by the present invention is widely derived from natural plants, is environment friendly, and has abundant resources. Application thereof in lithium-ion battery cathode and supercapacitor as a component of an aqueous binder or an oil binder leads to remarkable technical effect. The battery cost can be reduced and full water-based green production of the battery can be promoted. The terpene resin has a broad market prospect.

### BRIEF DESCRIPTION OF THE DRAWINGS

FIG. 1 is a test curve of the cycle performance of the lithium iron phosphate and the comparative electrode at a charge-discharge current density of 0.2 C according to embodiment 1 of the present invention.

FIG. 2 is a test comparison diagram of the impedance of the lithium iron phosphate and the comparative electrode at a 0.2 C rate according to embodiment 2 of the present invention.

FIG. 3 is a rate performance diagram of the lithium iron phosphate and the comparative electrode at different charge-discharge current densities according to embodiment 3 of the present invention.

FIG. 4 is a test curve of the cycle performance of the ternary material and the comparative electrode at a charge-discharge current density of 0.2 C according to embodiment 4 of the present invention.

FIG. 5 is a test comparison diagram of the impedance of the ternary material and the comparative electrode at a 0.2 C rate according to embodiment 5 of the present invention.

FIG. 6 is a rate performance diagram of the ternary material and the comparative electrode at different charge-discharge current densities according to embodiment 6 of the present invention.

FIG. 7 is a test curve of the cycle performance of the lithium iron phosphate and the comparative electrode at a charge-discharge current density of 0.2 C according to embodiment 7 of the present invention.

FIG. 8 is a rate performance diagram of the ternary material and the comparative electrode at different charge-discharge current densities according to embodiment 8 of the present invention.

FIG. 9 is the cycle stability curve of the activated carbon electrode at a current density of 200 mA/g according to embodiment 9 of the present invention.

Among them: Terpene resin is abbreviated as TX.

### DETAILED DESCRIPTION OF THE INVENTION

In order to better illustrate the purpose, technical solutions and advantages of the present invention, the present invention will be further described below with reference to specific embodiments.

The invention discloses a method for preparing electrodes of lithium-ion battery or supercapacitor by using a terpene resin-based composite binder, and a comparison test of the electrochemical performance between the lithium-ion battery made by the terpene resin-based composite binder and other binder or supercapacitor was conducted.

The water-soluble terpene resin emulsion (The model is 8218 aqueous terpene resin tackifying emulsion) or terpene resin solids used in the embodiments of the present invention were purchased from Guangzhou Songbao Chemical Co., Ltd.

### Embodiment 1

(1) Test Electrode Preparation

Lithium-ion battery cathode electrode according to an embodiment of the present invention includes a current collector and a lithium-ion battery cathode slurry loaded on the current collector; the lithium-ion battery cathode slurry includes a positive active material, a conductive agent, a binder and a solvent; and the mass ratio of the positive active material, the conductive agent and the binder is 90:5:5. The binder is a terpene resin-based aqueous binder, the terpene resin-based aqueous binder includes a water-soluble terpene resin emulsion and a water-soluble polymer auxiliary agent, the water-soluble polymer auxiliary agent is sodium carboxymethyl cellulose (CMC), the solvent is water. The positive active material is lithium iron phosphate; the conductive agent is acetylene black; the current collector is an aluminum foil current collector; the solid content of the lithium-ion battery cathode slurry is 45%, the viscosity of the lithium-ion battery cathode slurry is 4000 mPa·s. The lithium iron phosphate and the conductive agent were mixed and stirred until uniformly dispersed; the carboxymethyl cellulose was added to the deionized water to prepare a carboxymethyl cellulose aqueous solution, and the prepared carboxymethyl cellulose aqueous solution was added into the above system and stirred uniformly to obtain a mixture; the water-soluble terpene resin emulsion was then added to the above mixture (TX/CMC=1/50, 1/1, and 50/1, herein refers to the mass ratio) together with an appropriate amount of deionized water, and the mixture was stirred uniformly to obtain the lithium iron phosphate electrode slurry. The prepared lithium iron phosphate electrode slurry was uniformly coated on an aluminum foil and vacuum dried at 90° C. to obtain a lithium iron phosphate cathode electrode. Vacuum-dried electrodes were cut and weighed, and then assembled in a 2025 battery case in a glove box. The battery is assembled by using a lithium chip as counter electrode, a polyethylene film as separator and 1M LiPF₆EC/DMC/DEC (Lithium hexafluorophosphate ethylene carbonate/dimethyl carbonate/diethyl carbonate) (v/v/v=1/1/1) as electrolyte to conduct a galvanostatic charge-discharge test.

(2) Comparative Electrode Preparation

The polyvinylidene fluoride (PVDF) was used as a binder, a comparative electrode was prepared by the same method described above.

(3) Electrochemical Test

Electrochemical tests were performed on the charge-discharge cycle stability of the test electrode and the comparative electrode.

(4) Result Analysis

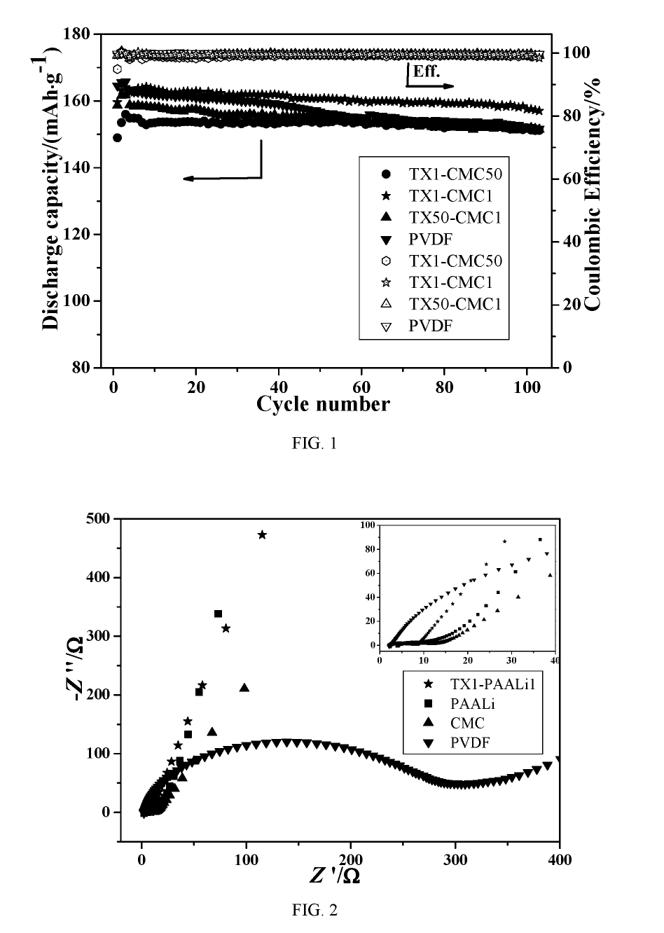

FIG. 1 is a test curve of the cycle performance of the test electrode and the comparative electrode at a charge-discharge current density of 0.2 C according to the present embodiment. Table 1 shows the corresponding capacity retention rate after 100 cycles. It can be seen from the table that after 100 cycles, capacity retention rate of the lithium iron phosphate electrode prepared by using TX/CMC of different ratios as a binder is higher than that of the lithium iron phosphate electrode prepared using PVDF as a binder.

### Table 1 Shows the Capacity Retention Rate of Lithium Iron Phosphate Cathode Materials Prepared with Different Binders after 100 Cycles at 0.2 C Rate

| | Capacity retention rate after 100 |
|---|---|
| Binder | cycles (%) |
| TX1/CMC50 | 97.64 |
| (TX/CMC = 1/50) | |
| TX1/CMC1 (TX/CMC = 1/1) | 96.46 |
| TX50/CMC1 | 95.42 |
| (TX/CMC = 50/1) | |
| PVDF | 92.82 |

### Embodiment 2

(1) Test Electrode Preparation

The difference between the present embodiment and embodiment 1 lies in that test electrode uses TX and PAALi as a binder, PAALi is lithium polyacrylate, the ratio of TX to PAALi is 1:1, herein refers to mass ratio.

(2) Comparative Electrode Preparation

PAALi, CMC, and PVDF were used as a binder respectively, comparative electrodes were prepared by the same method mentioned above.

(3) Electrochemical Test

The impedance test was performed on the test electrode and the comparative electrode after 100 cycles.

(4) Result Analysis

FIG. 2 shows the impedance test results of the lithium iron phosphate electrode after 100 cycles at 0.2 C rate according to the present embodiment, where the test electrode uses TX/PAALi as binder, the comparative electrode respectively uses PAALi, CMC and PVDF as binder. It can be seen from the figure that the impedance value of lithium iron phosphate electrode using TX/PAALi as the binder is relatively lower than that using PAALi, CMC and PVDF as binder.

### Embodiment 3

(1) Test Electrode Preparation

The difference between the present embodiment and embodiment 1 lies in that test electrode uses TX and PAANa as a binder, PAANa is sodium polyacrylate, the ratio of TX to PAANa is 1:1, 1:1.5 and 1.5:1, herein refers to a mass ratio.

(2) Comparative Electrode Preparation

Same as embodiment 1.

(3) Electrochemical Test

Electrochemical tests were performed on the charge-discharge cycle stability and rate performance of the test electrode and the comparative electrode.

(4) Result Analysis

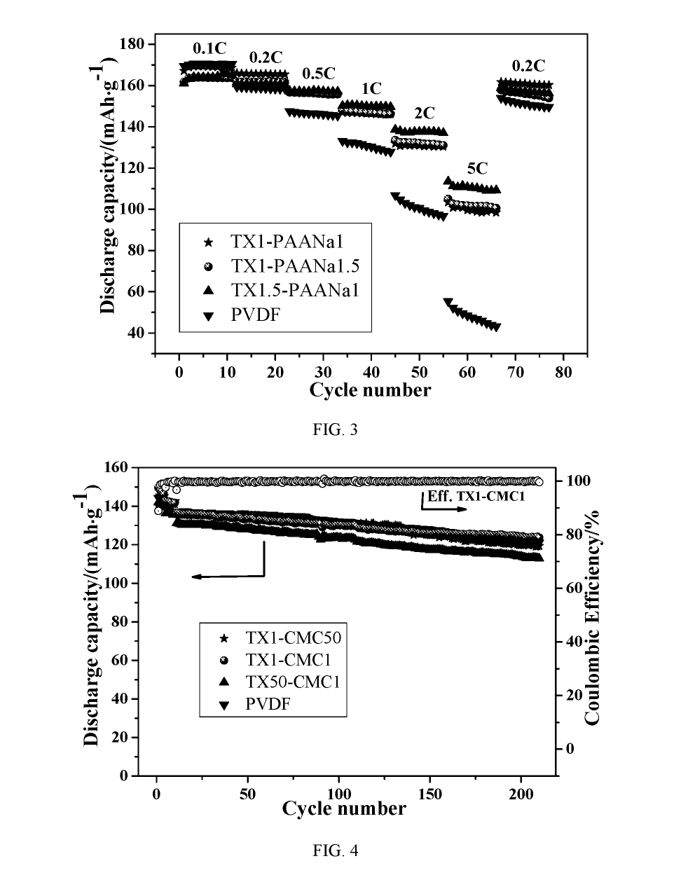

FIG. 3 is test curves showing the rate performance of the test electrode and the comparative electrode at different charge-discharge current densities according to the present embodiment. As can be seen from the figure, electrode using TX/PAANa as a lithium iron phosphate binder shows an excellent high rate characteristic. When the rate is higher than 0.5 C, the specific capacity of the lithium iron phosphate using TX/PAANa as a binder is much higher than that using PVDF as a binder. When the rate is 5 C, the specific capacity of the lithium iron phosphate using TX and PAANa in a ratio of 1.5:1 as a binder is 113.5 mAh/g, which is significantly higher than that of lithium iron phosphate with a PVDF binder (55.4 mAh/g).

### Embodiment 4

(1) Test Electrode Preparation

Lithium-ion battery cathode electrode according to an embodiment of the present invention includes a current collector and a lithium-ion battery cathode slurry loaded on the current collector; the lithium-ion battery cathode slurry includes a positive active material, a conductive agent, a binder and a solvent; and the mass ratio of the positive active material, the conductive agent and the binder is 85:9:6. The binder is a terpene resin-based aqueous binder, the terpene resin-based aqueous binder includes a water-soluble terpene resin emulsion and a water-soluble polymer auxiliary agent, the water-soluble polymer auxiliary agent is carboxymethyl cellulose (CMC), the solvent is water. The positive active material is ternary material (LiNi_{1.3}Mn_{1.3}Co_{1.3}O₂, NMC); the conductive agent is acetylene black; the current collector is an aluminum foil current collector; the solid content of the lithium-ion battery cathode slurry is 45%, the viscosity of the lithium-ion battery cathode slurry is 3000 mPa·s.

The NMC and the conductive agent were mixed and stirred until uniformly dispersed; the carboxymethyl cellulose was added to the deionized water to prepare a carboxymethyl cellulose aqueous solution, and the prepared carboxymethyl cellulose aqueous solution was added into the above system and stirred uniformly to obtain a mixture; the water-soluble terpene resin emulsion was then added to the above mixture (TX/CMC=1/50, 1/1, and 50/1, herein referred to the mass ratio) together with an appropriate amount of deionized water, and the mixture was stirred uniformly to obtain the NMC electrode slurry. The prepared NMC electrode slurry was uniformly coated on an Al foil and vacuum dried at 90° C. to obtain a NMC cathode electrode. Vacuum-dried electrodes were cut and weighed and then assembled in a 2025 battery case in a glove box. The battery is assembled by using a lithium chip as counter electrode, a polyethylene film as separator and 1M LiPF₆EC/DMC/DEC (v/v/v=1/1/1) as electrolyte to conduct a galvanostatic charge-discharge test.

(2) Comparative Electrode Preparation

The polyvinylidene fluoride (PVDF) was used as a binder, a comparative electrode was prepared by the same method described above.

(3) Electrochemical Test

Electrochemical tests were performed on the charge-discharge cycle stability of the test electrode and the comparative electrode.

(4) Result Analysis

FIG. 4 is a test curve of the cycle performance of the test electrode and the comparative electrode at a charge-discharge current density of 0.2 C according to the present embodiment. Table 2 shows the corresponding capacity retention rate after 200 cycles. It can be seen from the table that after 200 cycles, capacity retention rate of the NMC electrode prepared by using of TX and CMC in different ratios as a binder is substantially the same as or even higher than that prepared using PVDF as a binder.

### Table 2 Shows the Capacity Retention Rate of Ternary Positive Materials Prepared with Different Binders after 200 Cycles at 0.2 C Rate

| | Capacity retention rate after 200 |
|---|---|
| Binder | cycles (%) |
| TX1/CMC50 | 87.84 |
| (TX/CMC = 1/50) | |
| TX1/CMC1 (TX/CMC = 1/1) | 90.55 |
| TX50/CMC1 | 86.08 |
| (TX/CMC = 50/1) | |
| PVDF | 88.50 |

### Embodiment 5

### (1) Test Electrode Preparation

The difference between the present embodiment and embodiment 4 lies in that test electrode uses TX and PAALi as a binder, the ratio of TX to PAALi is 1:1, herein refers to a mass ratio.

### (2) Comparative Electrode Preparation

Same as embodiment 4.

### (3) Electrochemical Test

The impedance test was performed after 200 cycles on the test electrode and the comparative electrode.

### (4) Result Analysis

FIG. 5 shows the impedance test results of the ternary material electrode after 200 cycles at 0.2 C rate according to the present embodiment, where the test electrode uses TX and PAALi as binder, the comparative electrode uses PVDF as a binder. It can be seen from the figure that when the impedance value of ternary material electrode using TX and PAALi as the binder is relatively lower than that using PVDF as binder.

### Embodiment 6

(1) Test Electrode Preparation

The difference between the present embodiment and embodiment 4 lies in that test electrode uses TX and PAANa as a binder, the ratio of TX to PAANa is 1:1.

(2) Comparative Electrode Preparation

Same as embodiment 4

(3) Electrochemical Test

Electrochemical tests were performed on the charge-discharge cycle stability and rate performance of the test electrode and the comparative electrode.

(4) Result Analysis

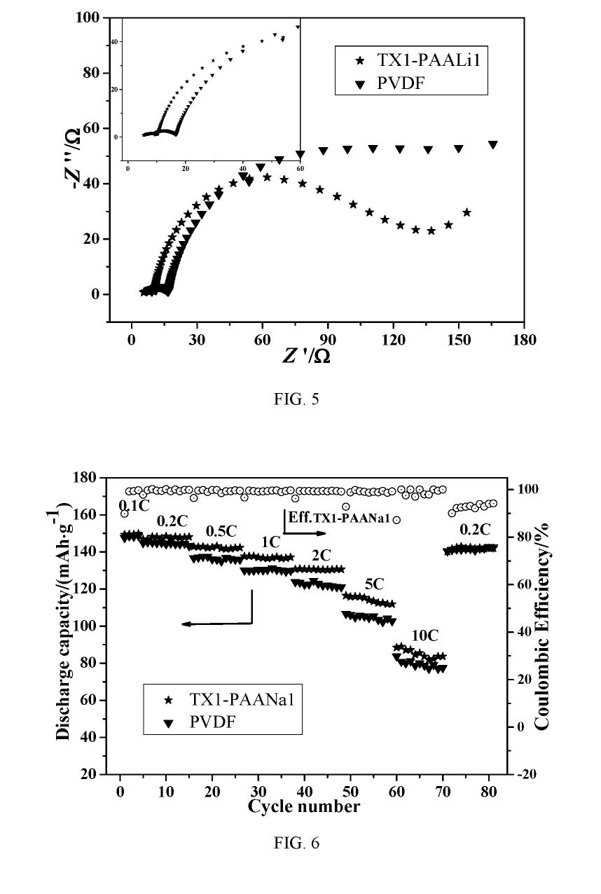

FIG. 6 is test curves of the rate performance of the test electrode and the comparative electrode at different charge-discharge current densities according to the present embodiment. As can be seen from the figure, electrode using TX and PAANa as ternary material binder shows excellent high rate characteristic. When the rate is higher than 0.5 C, the specific capacity of the ternary material using TX and PAANa as a binder is much higher than that using PVDF as a binder. When the rate is 5 C, the specific capacity of the ternary material prepared by using TX and PAANa in a ratio of 1:1 as a binder is 116.4 mAh/g, which is significantly higher than that of ternary material with a PVDF binder (106.7 mAh/g).

### Embodiment 7

(1) Test Electrode Preparation

Lithium-ion battery cathode electrode according to an embodiment of the present invention includes a current collector and a lithium-ion battery cathode slurry loaded on the current collector; the lithium-ion battery cathode slurry includes a positive active material, a conductive agent, a binder and a solvent; and the mass ratio of the positive active material, the conductive agent and the binder is 90:5:5. The binder is a terpene resin-based oil binder, the terpene resin-based oil binder includes an oil-soluble terpene resin and an oil-soluble polymer auxiliary agent, the oil-soluble polymer auxiliary agent is polyvinylidene fluoride (PVDF), the mass ratio of the oil-soluble terpene resin to the polyvinylidene fluoride is 1:4˜1:50, the solvent is N-methylpyrrolidone. The positive active material is lithium iron phosphate; the conductive agent is acetylene black; the current collector is an aluminum foil current collector; the solid content of the lithium-ion battery cathode slurry is 45%, the viscosity of the lithium-ion battery cathode slurry is 3000 mPa·s.

The lithium iron phosphate and the conductive agent were mixed and stirred until uniformly dispersed; the oil-soluble terpene resin was added to N-methylpyrrolidone (NMP) to obtain a terpene resin solution, and the obtained terpene resin solution was added to the above system and stirred uniformly to obtain a mixture; the PVDF was then added to the above-obtained mixture together with an appropriate amount of NMP, and the mixture was stirred uniformly to obtain an electrode slurry (solid content: 45%). The obtained slurry was uniformly coated on an Al foil and fully dried to obtain the lithium iron phosphate cathode electrode. Vacuum-dried electrodes were cut and weighed, and then assembled in a 2025 battery case in a glove box. The battery is assembled by using a lithium chip as counter electrode, a polyethylene film as separator and 1M LiPF₆EC/DMC/DEC (v/v/v=1/1/1) as electrolyte to conduct a galvanostatic charge-discharge test.

(2) Comparative Electrode Preparation

The polyvinylidene fluoride (PVDF) was used as a binder (without terpene resin), a comparative electrode was prepared by the same method described above.

(3) Electrochemical Test

Electrochemical tests were performed on the charge-discharge cycle stability of the test electrode and the comparative electrode.

(4) Result Analysis

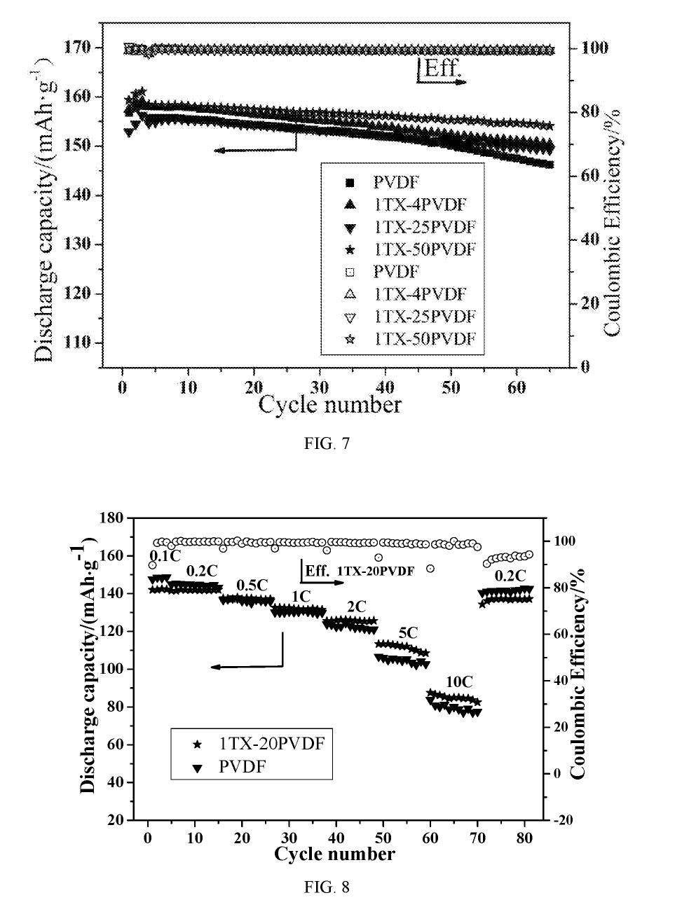

FIG. 7 is test curves of the cycle performance of the test electrode and the comparative electrode at a charge-discharge current density of 0.2 C according to the present embodiment. Table 3 shows the corresponding capacity retention rate after 65 cycles. It can be seen from the table that after 65 cycles, capacity retention rate of the lithium iron phosphate electrode prepared by using TX and PVDF in different ratios (1:4, 1:25 and 1:50, herein refers to mass ratio) as a composite binder is higher than that of the lithium iron phosphate electrode prepared using PVDF as a binder.

### Table 3 Shows the Capacity Retention Rate of Lithium Iron Phosphate Cathode Materials Prepared with Different Binders after 65 Cycles at 0.2 C Rate

| | Capacity retention rate after 65 |
|---|---|
| Binder | cycles (%) |
| PVDF | 93.93 |
| 1TX-4PVDF(TX:PVDF = 1:4) | 95.17 |
| 1TX-25PVDF(TX:PVDF = 1:25) | 96.50 |
| 1TX-50PVDF(TX:PVDF = 1:50) | 97.25 |

### Embodiment 8

(1) Test Electrode Preparation

Lithium-ion battery cathode electrode according to an embodiment of the present invention includes a current collector and a lithium-ion battery cathode slurry loaded on the current collector; the lithium-ion battery cathode slurry includes a positive active material, a conductive agent, a binder and a solvent; and the mass ratio of the positive active material, the conductive agent and the binder is 85:9:6. The binder is a terpene resin-based oil binder, the terpene resin-based oil binder includes an oil-soluble terpene resin and an oil-soluble polymer auxiliary agent, the oil-soluble polymer auxiliary agent is polyvinylidene fluoride (PVDF), the mass ratio of the oil-soluble terpene resin to the polyvinylidene fluoride is 1:20, the solvent is N-methylpyrrolidone (NMP). The positive active material is ternary material (LiNi_{1/3}Mn_{1/3}Co_{1/3}O₂, NMC); the conductive agent is acetylene black; the current collector is an aluminum foil current collector; the solid content of the lithium-ion battery cathode slurry is 45%, the viscosity of the lithium-ion battery cathode slurry is 4000 mPa·s.

The ternary material and the conductive agent were mixed and stirred until uniformly dispersed; the oil-soluble terpene resin was added to N-methylpyrrolidone (NMP) to obtain a terpene resin solution, and the obtained terpene resin solution was added to the above system and stirred uniformly to obtain a mixture; the PVDF was then added to the above-obtained mixture together with an appropriate amount of NMP, and the mixture was stirred uniformly to obtain an electrode slurry (solid content: 45%). The obtained slurry was uniformly coated on an Al foil and fully dried to obtain the ternary material cathode electrode. Vacuum-dried electrodes were cut and weighed, and assembled in a 2025 battery case in a glove box. The battery is assembled by using a lithium chip as counter electrode, a polyethylene film as separator and 1M LiPF₆EC/DMC/DEC (v/v/v=1/1/1) as electrolyte to conduct a galvanostatic charge-discharge test.

(2) Comparative Electrode Preparation

The polyvinylidene fluoride (PVDF) was used as a binder (without terpene resin), a comparative electrode was prepared in the same manner.

(3) Electrochemical Test

Electrochemical tests were performed on the charge-discharge cycle stability and the rate performance of the test electrode and the comparative electrode.

(4) Result Analysis

FIG. 8 shows test curves of the rate performance of the test electrode and the comparative electrode at different charge-discharge current density according to the present embodiment. As can be seen from the figure, the ternary material electrode prepared by using TX-PVDF with a mass ratio of 1:20 as a composite binder shows an excellent high rate characteristic. When the rate is higher than 2 C, the rate performance of the ternary material using TX-PVDF as a binder is much higher than that of ternary material with a PVDF binder. When the rate is 5 C, the specific capacity of the ternary material prepared by using TX-PVDF as a binder is 113.3 mAh/g, which is significantly higher than that of ternary material with a PVDF binder (106.7 mAh/g).

### Embodiment 9

(1) Test Electrode Preparation

Supercapacitor electrode according to an embodiment of the present invention includes a current collector and an electrode slurry loaded on the current collector; the electrode slurry includes a positive active material, a conductive agent, a binder and a solvent; and the mass ratio of the positive active material, the conductive agent and the binder is 85:10:5. The binder is a terpene resin-based oil binder, the terpene resin-based oil binder includes an oil-soluble terpene resin and an oil-soluble polymer auxiliary agent, the oil-soluble polymer auxiliary agent is polyvinylidene fluoride (PVDF), the mass ratio of the oil-soluble terpene resin to the polyvinylidene fluoride is 1:50, the solvent is N-methylpyrrolidone (NMP). The positive active material is activated carbon (C); the conductive agent is acetylene black; the current collector is an aluminum foil current collector; the solid content of the supercapacitor electrode slurry is 40%, the viscosity of the supercapacitor electrode slurry is 4000 mPa·s.

The activated carbon and the conductive agent were mixed and stirred until uniformly dispersed. The oil-soluble terpene resin was added to N-methylpyrrolidone (NMP) to obtain a terpene resin solution, and the obtained terpene resin solution was added to the above system and stirred uniformly to obtain a mixture; the PVDF was then added to the above-obtained mixture together with an appropriate amount of NMP, and the mixture was stirred uniformly to obtain an electrode slurry (solid content: 40%); The obtained slurry was uniformly coated on an Al foil and fully dried to obtain the activated carbon electrode. Vacuum-dried electrodes were cut and weighed, the electrodes and the diaphragm were placed in the button battery case, and the electrolyte was added dropwise and sealed to form a symmetrical activated carbon supercapacitor, the cyclic stability test was conducted.

(2) Electrochemical Test

Cycle stability test of the test electrode was performed at a current density of 200 mA/g.

(3) Result Analysis

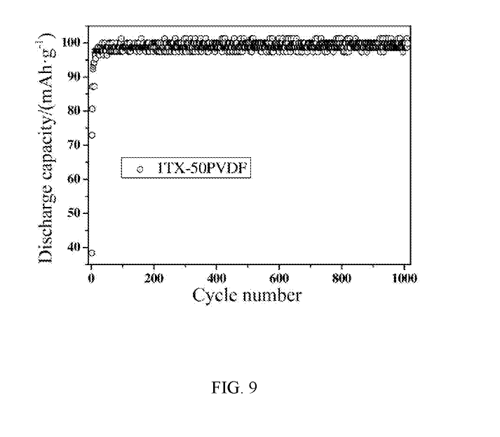

FIG. 9 shows the cycle stability curve of the activated carbon electrode prepared by using the TX/PVDF binder at a current density of 200 mA/g (0-2.5 V). The activated carbon electrode prepared by using the TX/PVDF binder has a Coulomb efficiency of more than 97% (except for the first 10 times) after 1000 cycles, and the supercapacitor exhibits a good cycle stability.

Although the present invention has been described herein with reference to the illustrative embodiments of the present invention, the above embodiments are merely preferred embodiments of the present invention, and the scope of the present invention is not limited to the above embodiments, and it should be understood that the technician in this field can design many other modifications and embodiments, such modifications and embodiments derived from the spirit of the present invention will fall within the scope and spirit of the principles disclosed in this application.

1. (canceled)

2. A terpene resin-based composite binder, comprising a terpene resin-based aqueous binder or a terpene resin-based oil binder; and wherein
the terpene resin-based aqueous binder comprises a water-soluble terpene resin emulsion and a water-soluble polymer auxiliary agent, the water-soluble polymer auxiliary agent is one or more selected from the group consisting of carboxymethyl cellulose, polyacrylic acid and metal salts, a mass ratio of a terpene resin in the water-soluble terpene resin emulsion to the water-soluble polymer auxiliary agent is 50:1 to 1:50;
the terpene resin-based oil binder comprises an oil-soluble terpene resin and an oil-soluble polymer auxiliary agent, the oil-soluble polymer auxiliary agent is a polyvinylidene fluoride, a mass ratio of the oil-soluble terpene resin to the polyvinylidene fluoride ranges from 1:4 to 1:50.

3. A lithium-ion battery cathode electrode, wherein the lithium-ion battery cathode electrode comprises a current collector and a lithium-ion battery cathode slurry loaded on the current collector; the lithium-ion battery cathode slurry comprises a positive active material, a conductive agent, a binder and a solvent;
the binder is a terpene resin-based composite binder; and a mass ratio of the positive active material, the conductive agent and the binder is 70-95:1-20:4-10.

4. The lithium-ion battery cathode electrode according to claim 3, wherein the binder is a terpene resin-based aqueous binder, the terpene resin-based aqueous binder comprises a water-soluble terpene resin emulsion and a water-soluble polymer auxiliary agent, the water-soluble polymer auxiliary agent is one or more selected from the group consisting of carboxymethyl cellulose, polyacrylic acid and metal salts; a mass ratio of a terpene resin in the water-soluble terpene resin emulsion to the water-soluble polymer auxiliary agent ranges from 50:1 to 1:50; and the solvent is water.

5. The lithium-ion battery cathode electrode according to claim 3, wherein the binder is a terpene resin-based oil binder, the terpene resin-based oil binder comprises an oil-soluble terpene resin and an oil-soluble polymer auxiliary agent, the oil-soluble polymer auxiliary agent is a polyvinylidene fluoride, a mass ratio of the oil-soluble terpene resin to the polyvinylidene fluoride ranges from 1:4 to 1:50, and the solvent is N-methylpyrrolidone.

6. The lithium-ion battery cathode electrode according to claim 3, wherein the positive active material is one or more selected from the group consisting of lithium iron phosphate, lithium cobalt oxide, lithium manganate and ternary material; the conductive agent is a conductive carbon material; the current collector is an aluminum foil current collector;
a solid content of the lithium-ion battery cathode slurry ranges from 30% to 75%, a viscosity of the lithium-ion battery cathode slurry ranges from 3000 mPa·s to 8000 mPa·s.

7. A supercapacitor electrode, comprising: a current collector and an electrode slurry loaded on the current collector; the electrode slurry comprises an active material, a conductive agent, a binder and a solvent; wherein
the binder is a terpene resin-based oil binder; a mass ratio of the active material, the conductive agent and the binder is 70-95:1-20:4-10;
the active material is an activated carbon, the conductive agent is a conductive carbon material, the current collector is an aluminum foil current collector, a solid content of the electrode slurry of the supercapacitor electrode ranges from 30% to 75%, a viscosity of the electrode slurry of the supercapacitor electrode ranges from 3000 mPa·s to 8000 mPa·s.

8. The supercapacitor electrode according to claim 7, wherein the terpene resin-based oil binder comprises an oil-soluble terpene resin and an oil-soluble polymer auxiliary agent, the oil-soluble polymer auxiliary agent is a polyvinylidene fluoride, a mass ratio of the oil-soluble terpene resin to the polyvinylidene fluoride ranges from 1:4 to 1:50, the solvent is N-A Pyrrolidone.

9. A lithium-ion battery, comprising a lithium-ion battery cathode electrode,
wherein the lithium-ion battery cathode electrode comprises a current collector and a lithium-ion battery cathode slurry loaded on the current collector; the lithium-ion battery cathode slurry comprises a positive active material, a conductive agent, a binder and a solvent;
the binder is a terpene resin-based composite binder; and a mass ratio of the positive active material, the conductive agent and the binder is 70-95:1-20:4-10.

10. A supercapacitor, comprising a supercapacitor electrode;
wherein the supercapacitor electrode comprises a current collector and an electrode slurry loaded on the current collector; the electrode slurry comprises an active material, a conductive agent, a binder and a solvent;
the binder is a terpene resin-based oil binder; a mass ratio of the active material, the conductive agent and the binder is 70-95:1-20:4-10;
the active material is an activated carbon, the conductive agent is a conductive carbon material, the current collector is an aluminum foil current collector, a solid content of the electrode slurry of the supercapacitor electrode ranges from 30% to 75%, a viscosity of the electrode slurry of the supercapacitor electrode ranges from 3000 mPa·s to 8000 mPa·s.

11. The lithium-ion battery according to claim 9, wherein the binder is a terpene resin-based aqueous binder, the terpene resin-based aqueous binder comprises a water-soluble terpene resin emulsion and a water-soluble polymer auxiliary agent, the water-soluble polymer auxiliary agent is one or more selected from the group consisting of carboxymethyl cellulose, polyacrylic acid and metal salts; a mass ratio of a terpene resin in the water-soluble terpene resin emulsion to the water-soluble polymer auxiliary agent ranges from 50:1 to 1:50; and the solvent is water.

12. The lithium-ion battery according to claim 9, wherein the binder is a terpene resin-based oil binder, the terpene resin-based oil binder comprises an oil-soluble terpene resin and an oil-soluble polymer auxiliary agent, the oil-soluble polymer auxiliary agent is a polyvinylidene fluoride, a mass ratio of the oil-soluble terpene resin to the polyvinylidene fluoride ranges from 1:4 to 1:50, and the solvent is N-methylpyrrolidone.

13. The lithium-ion battery according to claim 9, wherein the positive active material is one or more selected from the group consisting of lithium iron phosphate, lithium cobalt oxide, lithium manganate and ternary material; the conductive agent is a conductive carbon material; the current collector is an aluminum foil current collector; a solid content of the lithium-ion battery cathode slurry ranges from 30% to 75%, a viscosity of the lithium-ion battery cathode slurry ranges from 3000 mPa·s to 8000 mPa·s.

14. The supercapacitor according to claim 10, wherein the terpene resin-based oil binder comprises an oil-soluble terpene resin and an oil-soluble polymer auxiliary agent, the oil-soluble polymer auxiliary agent is a polyvinylidene fluoride, a mass ratio of the oil-soluble terpene resin to the polyvinylidene fluoride ranges from 1:4 to 1:50, and the solvent is N-A Pyrrolidone.
